(19) United States
(12) Patent Application Publication
(10) Pub. No.: US 2010/0286016 A1
(43) Pub. Date: Nov. 11, 2010

(54) Non-V.O.C. sprayable gel to remove insect bodies-environmentally friendly

(75) Inventors: ROBERT JOSEPH HECKING, Cincinnati, OH (US); Marvel Fields, Cincinnati, OH (US)

Correspondence Address: ROBERT J. HECKING;Suite N1-320, 2692 Madison Rd, Cincinnati, OH, 45208, US

(73) Assignee: KLC Brands, Inc., Cincinnati, OH (US)

(21) Appl. No.: 12/752,333

(22) Filed: Apr. 1, 2010

(51) Int. Cl. C11D 3/08

(52) U.S. Cl. 510/180; 510/189; 510/109

(57) ABSTRACT

This non-V.O.C. gel formula eliminates the need for harsh chemicals or environmentallly harmful solvents to remove dried dead bugs from windshields, headlights and vehicle grilles and bumpers. Prior art is to include solvents in the cleaning formula which can damage plastic headlight covers by making them hazy, or the use of detergents and scrub brushes or pads which can damage paint finishes and plastic components

### DISCUSSION

In U.S. Pat. No. 6,967,190, use dodecyl pyrrolidine, and ethoxylated alcohols to provide superior wetting and spreading of wetting agents to remove road film and bug remains. Dodecyl pyrrolidine is highly toxic to fish if leaked into waterways, it causes boils if ingested, and is highly irritating to skin and eyes. Our product does not use these aggressive chemical

In U.S. Pat. No. 6,596,677 the invention is the use of Propylene Carbonate, Glycol Ethers, and an acid activator. Propylene Carbonate can affect breathing and is mildly flammable, and Glycol Ethers are known V.O.C. limited by Regulatory agencies. Our product uses neither chemical.

In U.S. Pat. No. 6,017,872 the preferred embodiement of the bug removing formula requires Aromatic Sulfonates, low flash point alcohols such as methanol, ethanol or propanol also V.O.C.'s and glycol monoalkyl ethers also V.O.C. The invention relies on strong chemical cleaners

In U.S. Pat. No. 6,511,950 the preferred embodiement of this road film bug remover used an organic thickener, methyl cellulose, which can make work areas slippery with Myristyltrimethyl ammonium bromide, EDTA ammonia and ethanol as an aggressive chemical wetting product. Our product does not contain any of the preferred embodiements

In U.S. Pat. No. 6,350,725 the preferred embodiement reuires propoxylated quaternary ammonium cationic surfactant, linear ethoxylated alcohols, Alkyl Benzene Sulfonate. Caustic soda, and glycol ethers. Our product does not contain any of these aggressive cleaning agents

In U.S. Pat. No. 5,591,376 the preferred embodiement contains alkyl polyglucosides for rinsability and biodegradeability, but does not refer to bug body removal, just cleaning of cars. Our product does not employ alkyl polyglucosides.

### FIELD OF INVENTION

Car Washes, and Car Detailers currently apply liquid detergents on to car surfaces with dried on bug remains to remove them. The bug bodies contain acids which if not removed penetrate car finishes and stain them or leave tiny holes in the car's paint, compromising the protective feature of the paint. These liquid detergent solutions in water, runoff car surfaces before the water or the detergent can loosen the baked on bug bodies, thus requiring a stiff brush to scrub bodies off, potentially scratching plastic and paint finishes.

Bug and Tar removers with organic solvents add Volatile Organic Compounds to the air, which are responsible for smog, and are limited by many states under V.O.C. laws, comprimising effectiveness. These solvents evaporate quickly before bug bodies can be softened for removal

REFERENCES CITED (REFERENCED BY)

U.S. Patent Documents

| | | |
|---|---|---|
| 6,967,190 | Nov. 22, 2005 | Narayanan |
| 6,596,677 | Jul. 22, 2003 | Machac, Jr. Huntsman Chemical |
| 6,017,872 | Jan. 25, 2000 | Pedersen et al Ecolabs |
| 6,511,950 | Jan. 28, 2003 | Jenevein, Earl (Robert LA) |
| 6,350,725 | Feb. 26, 2002 | Levitt et al Ecolabs |
| 5,591,376 | Jan. 7, 1997 | Kiewart et al Henkel-Germany |

What is claimed is:

1. An inorganic clay based gel which is sprayable from a pump spray bottle, that turns back into a water saturated gel which sticks to car surfaces and does not drip or run off surface, allowing water and surfactant to soften dried on bug bodies stuck to windshields, bumpers and grilles of car and remove them without scrubbing which could damage paint finishes.

2. Most bug and tar removal products contain volatile organic compounds that could cause hazing of plastic headlight covers, and penetrate paint finishes. This gel has no volatile organic components.

3. The gel contains a mild detergent at 0.25% to 1%, which could be from several groups, such as: soaps-sodium stearate, sodium oleate, sodium laurate, or the potassium soaps of these molecules. Or detergents such as Sodium Lauryl Sulfate, Sodium Alkyl Benzene Sulfonates, Sodium Succinate or other emulsifiers that do not harm plastic, rubber or paint surfaces of car.

4. The gel is made with 1 to 5% of Laponite

5. Gel is not slippery on ground when rinsed off like organic based gels.
